(19) United States
(12) Patent Application Publication
(10) Pub. No.: US 2012/0016114 A1
(43) Pub. Date: Jan. 19, 2012

(54) PROCESS FOR THE PREPARATION OF MONOETHYLENICALLY UNSATURATED GLYCOSYLAMINES

(75) Inventors: Harald Keller, Ludwigshafen (DE); Mario Emmeluth, Bensheim (DE); Tim Balensiefer, Mannheim (DE); Paola Uribe Arocha, Mannheim (DE); Francesca Aulenta, Mannheim (DE)

(73) Assignee: BASF SE, Ludwigshafen (DE)

(21) Appl. No.: 13/260,042

(22) PCT Filed: Mar. 30, 2010
(86) PCT No.: PCT/EP2010/054211

§ 371 Date: Sep. 23, 2011

(30) Foreign Application Priority Data
Apr. 15, 2009 (EP) 09157961.5

(51) Int. Cl. C08B 31/00

(52) U.S. Cl. 536/45

(57) ABSTRACT

The present invention relates to a process for the preparation of monoethylenically unsaturated glycosylamines, in which an aldehyde sugar is reacted with a primary aliphatic amine or ammonia in aqueous medium and, without interim isolation, is reacted with the anhydride of a monounsaturated carboxylic acid, or an aldehyde sugar is reacted directly with allylamine, and to a process for the preparation of polymers which comprise N-acylated glycosylamine groups in copolymerized form, and to novel unsaturated N-maleinylated glycosylamines.

The invention relates to a process for the preparation of monoethylenically unsaturated glycosylamines and to a process for the preparation of polymers which comprise N-acylated glycosylamine groups in copolymerized form.

Unsaturated N-acylated glycosylamines or N-allylglycosides are accessible in various ways. The targeted chemical synthesis of unsaturated N-acylated glycosylamines is difficult on account of the high functionality of the sugar radical.

For example, WO 90/10023 describes oligomeric N-acryloyl- and N-(meth)acryloyl-glycosylamines whose (meth)acryloyl radical is located in the anomeric position. For the preparation, the disaccharides are converted with ammonium hydrogencarbonate in water into the corresponding glycosylamine. Following interim isolation, the glycosylamine is N-acylated by means of acryloyl chloride in tetrahydrofuran as solvent. The process described for this is, at a reaction time of 6-14 days, very long.

The acryloyl chloride described in the literature for introducing acryloyl radicals leads to a product mixture with a high salt content which has to be separated off by means of complex purification steps.

It was an object of the invention to develop a process for the preparation of monoethylenically unsaturated glycosylamines which at least partly avoids the above-described disadvantages of the prior art. The synthesis should be selective especially for a good yield of desired monoethylenically unsaturated glycosylamines, i.e. be able to be carried out without the formation of polyamines and thus without the formation of a plurality of free-radically polymerizable double bonds in a cost-effective manner. In addition, the preparation process should have a good space-time yield.

Surprisingly, the above object was achieved through the targeted selection of process conditions, in particular by working in an aqueous medium at a relatively low absolute fraction of organic solvent (based on the amount of aldehyde sugar used).

Accordingly, a process for the preparation of monoethylenically unsaturated glycosylamines has been found in which an aldehyde sugar is reacted with a primary aliphatic amine or ammonia in aqueous medium and, without interim isolation, reacted with the anhydride of a monounsaturated carboxylic acid, or an aldehyde sugar is reacted directly with allylamine. Furthermore, the present invention relates to a process for the preparation of polymers which comprise N-acylated glycosylamine groups in copolymerized form, and also to novel unsaturated N-maleinylated glycosylamines.

According to one embodiment, the preparation of monoethylenically unsaturated N-acylated glycosylamines takes place in two steps: by reacting an aldehyde sugar with a primary aliphatic amine or ammonia to give the corresponding glycosylamine and reacting the resulting N-glycosylamine with the anhydride of an unsaturated carboxylic acid to give the monoethylenically unsaturated N-acylated glycosylamine. According to the invention, the two process steps are carried out directly in succession, i.e. without interim isolation.

According to a second embodiment, the preparation of N-allylglycosides takes place by reacting an aldehyde sugar directly with allylamine in aqueous medium.

Unless stated otherwise, within the context of this application, C₁-C₈-alkyl is methyl, ethyl, n-propyl or isopropyl, n-, sec- or tert-butyl, n- or tert-amyl, and also n-hexyl, n-heptyl and n-octyl and also the mono- or poly-branched analogs thereof.

In the text below, aldehyde sugars are to be understood as meaning reducing sugars which carry an aldehyde group in their open-chain form. The aldehyde sugars used according to the invention are open-chain or cyclic mono- and oligosaccharides from natural and synthetic sources with an aldehyde radical or its hemiacetal. In particular, the aldehyde sugars are selected from mono- and oligosaccharides in optically pure form. They are also suitable as stereoisomer mixtures.

Monosaccharides are selected from aldoses, in particular aldopentoses and preferably aldohexoses. Suitable monosaccharides are, for example, arabinose, ribose, xylose, mannose and galactose, in particular glucose. Since the monosaccharides are reacted in aqueous solution, they are present, on account of the mutarotation, both in ring-shaped hemiacetal form and also, to a certain percentage, in open-chain aldehyde form.

The aldehyde sugar is preferably an oligosaccharide. Oligosaccharides are understood as meaning compounds with 2 to 20 repeat units. Preferred oligosaccharides are selected from di-, tri-, tetra-, penta- and hexa-, hepta-, octa-, nona- and decasaccharides, preferably saccharides having 2 to 9 repeat units. The linkage within the chains takes place 1,4-glycosidically and if appropriate 1,6-glycosidically. The aldehyde sugars, even if they are oligomeric aldehyde sugars, have one reducing group per molecule.

Preferably, the aldehyde sugars (saccharides) used are compounds of the general formula I

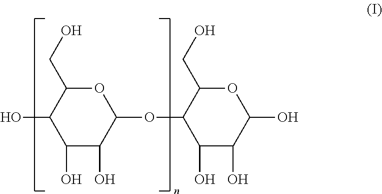

in which n is the number 0, 1, 2, 3, 4, 5, 6, 7 or 8.

The oligosaccharides in which n is an integer from 1 to 8 are particularly preferred. In this connection it is possible to use oligosaccharides with a defined number of repeat units. As oligosaccharides, mention may be made, for example, of lactose, maltose, isomaltose, maltotriose, maltotetraose and maltopentaose.

Mixtures of oligosaccharides with a different number of repeat units are preferably selected. Mixtures of this type are obtainable through hydrolysis of a polysaccharide, preferably of cellulose or starch, such as enzymatic or acid-catalyzed hydrolysis of cellulose or starch. Vegetable starch consists of amylose and amylopectin as main constituent of the starch. Amylose consists of predominantly unbranched chains of glucose molecules which are 1,4-glycosidically linked together. Amylopectin consists of branched chains in which, besides the 1,4-glycosidic linkages, there are additionally 1,6-glycosidic linkages, which lead to branches. Also of suitability according to the invention are hydrolysis products of amylopectin as starting compound for the process according to the invention and are encompassed by the definition of oligosaccharides.

Primary aliphatic amines that are suitable according to the invention may be linear or branched. Within the context of this invention, primary aliphatic amines are aliphatic monoamines, preferably saturated monoamines, with a primary amino group. The saturated aliphatic radical is generally an alkyl radical having preferably 1 to 8 carbon atoms, which may be interrupted by O atoms and which, if appropriate, may carry one or two carboxyl groups, hydroxyl groups and/or carboxamide groups.

Primary aliphatic amines substituted by hydroxyl, carboxyl or carboxamide that are suitable according to the invention are alkanolamines such as ethanolamine, and amino acids such as glycine, alanine, phenylalanine, serine, asparagine, glutamine, aspartic acid and glutamic acid.

Primary aliphatic amines whose alkylene radical is interrupted by oxygen that are suitable according to the invention are preferably 3-methoxypropylamine, 2-ethoxyethylamine and 3-(2-ethylhexyloxy)propylamine.

The primary aliphatic amines used are preferably C₁-C₈-alkylamines, in particular C₁-C₄-alkylamines, such as ethylamine, 1-aminopropane, 2-aminopropane, 1-aminobutane, 2-aminobutane, in particular methylamine.

The primary aliphatic amines are preferably selected from methylamine and ethanolamine. Furthermore, the reaction with ammonia or mixtures of ammonia with primary aliphatic amines is preferred.

The anhydrides of a monounsaturated carboxylic acid used according to the invention (also referred to below as “anhydride”) are preferably selected from acrylic anhydride, the anhydrides of C₁-C₆-alkyl-substituted acrylic acid, itaconic anhydride, and maleic anhydride. They are preferably selected from methacrylic anhydride, acrylic anhydride, itaconic anhydride and maleic anhydride.

The monoethylenically unsaturated N-maleinylated glycosylamines obtained as a result of the reaction with maleic anhydride are novel and are likewise provided by the present invention.

The novel monoethylenically unsaturated N-maleinylated glycosylamines obey the general formula II

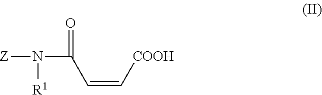

in which
Z is the radical of an aldehyde sugar, the bond of which takes place via the anomeric carbon, i.e. is an N-glycosidic bond,
R¹ is hydrogen or C₁-C₈-alkyl which is optionally interrupted by oxygen atoms and/or which optionally carries one or two carboxyl groups, hydroxyl groups and/or carboxamide groups.

Preferably, Z is hydrogen or C₁-C₄-alkyl, in particular methyl, or C₁-C₄-hydroxyalkyl.

Preferably, Z is a radical of the general formula III

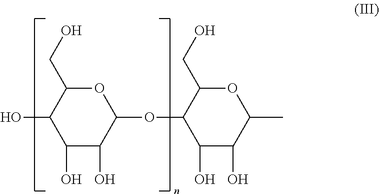

in which n is the number 0, 1, 2, 3, 4, 5, 6, 7 or 8.

The conversion to the monoethylenically unsaturated glycosylamine takes place in aqueous medium. Here, aqueous medium is to be understood as meaning water as well as mixtures of water with up to 50% by weight, based on the mixture, of at least one organic solvent. Suitable organic solvents are those which at 20° C. are miscible with water at least to a limited degree, in particular completely. This is understood as meaning a miscibility of at least 50% by weight of solvent in water at 20° C. Suitable organic solvents are C₁-C₃-alkanols, e.g. methanol, ethanol, propanol, isopropanol, ketones, such as acetone, methyl ethyl ketone, mono-, oligo- or polyalkylene glycols, which have C₂-C₆-alkylene units, such as ethylene glycol, 1,2- or 1,3-propylene glycol, 1,2- or 1,4-butylene glycol, C₁-C₄-alkyl ethers of polyhydric alcohols, such as ethylene glycol monomethyl or monoethyl ethers, diethylene glycol monomethyl or monoethyl ether, diethylene glycol monobutyl ether (butyl diglycol) or triethylene glycol monomethyl or monoethyl ether, C₁-C₄-alkyl esters of polyhydric alcohols, glycerol, γ-butyrolactone, ethylene carbonate, propylene carbonate, dimethyl sulfoxide or tetrahydrofuran. Preferred organic solvents are acetone, methanol, ethanol and tetrahydrofuran.

The concentration of aldehyde sugar is generally 10 to 40% by weight, based on the aqueous medium.

According to the invention, the molar ratio of primary aliphatic amine to aldehyde sugar can vary within a wide range, preferably in the ratio from 5:1 to 0.5:1, in particular 3:1 to 0.8:1. Particular preference is given to a molar ratio of primary aliphatic amine to aldehyde sugar of from 2:1 to 1:1.

In the case of the aldehyde sugars, the molar ratio is not based on the number of molecules, but on the number of reducing ends (aldehyde groups). This means that 1 mol of aldehyde sugar is the amount of aldehyde sugar which comprises 6.02217*10²³ reducing ends.

According to the invention, the molar ratio of anhydride to primary aliphatic amine can vary in a range from 2:1 to 0.8:1, preferably in a range from 1.2:1 to 0.9:1, particularly preferably in a range from 1.1:1 to 0.95:1.

The reaction can take place continuously, for example in a tubular reactor or in a stirred-reactor cascade, or discontinuously.

The reaction can be carried out in all reactors suitable for such a reaction. Such reactors are known to the person skilled in the art. Preferably, the reaction takes place in a stirred-tank reactor.

To mix the reaction mixture, any methods may be used. Special stirring devices are not required. The reaction medium is single-phase and the reactants are dissolved, suspended or emulsified therein. The temperature is adjusted to the desired value during the reaction and can, if desired, be increased or decreased during the course of the reaction.

During the reaction procedure according to the invention, over and above the storage stabilizer that is usually present anyway in the anhydride, additional stabilizer can be added to the reaction mixture, for example hydroquinone monomethyl ether, phenothiazine, phenols, such as, for example, 2-tert-butyl-4-methylphenol, 6-tert-butyl-2,4-dimethylphenol or N-oxyls, such as 4-hydroxy-2,2,6,6-tetramethyl-piperidine N-oxyl, 4-oxo-2,2,6,6-tetramethylpiperidine N-oxyl or Uvinul® 4040P from BASF SE or amines such as Kerobit® BPD from BASF SE (N,N′-di-sec-butyl-p-phenylenediamine), for example in amounts of from 0.5 to 100 ppm, based on the total mixture.

The reaction is advantageously carried out in the presence of an oxygen-containing gas, preferably air or air/nitrogen mixtures.

During the reaction of the primary aliphatic amine with the aldehyde sugar, the temperature can be in the range from 0° C. to 90° C., preferably in the range from 15° C. to 40° C. The reaction time is usually in the range from about 1 to 24 hours, preferably in the range from 2 to 6 hours.

During the reaction with anhydrides, the temperature can be in the range from −5° C. to 40° C., preferably in the range from −1° C. to 25° C. The reaction time is usually in the range from about 5 to 40 hours, preferably in the range from 10 to 20 hours.

The acid which may be produced during the amine formation from the anhydride as a further product, for example acrylic acid in the case of acrylic anhydride or methacrylic acid in the case of methacrylic anhydride, can be removed from the reaction equilibrium continuously or stepwise in a suitable manner. Of suitability for this are preferably molecular sieves (pore size e.g. in the range from about 3-10 angstroms), or a separation by means of distillation or with the help of suitable semipermeable membranes. However, it is advantageous not to remove them, but to co-use them directly as comonomer for the polymerization.

At the end of the reaction, the desired monounsaturated N-acylated glycosylamine or N-allylglycoside can, if required, be separated off, e.g. chromatographically, from the organic solvent, purified, and then used for the preparation of the desired polymers. However, it is usually entirely adequate to separate off the organic diluent prior to the further reaction, for example by distillation.

The process according to the invention is characterized by a low fraction of organic solvents. In this way, complex isolation processes prior to the further reaction can be avoided. Instead it is possible to use the resulting reaction mixture directly for the further polymerization. The process according to the invention has, as a “one-pot” process, a good space-time yield and can be carried out cost-effectively.

The invention further provides processes for the preparation of polymers which comprise N-acylated glycosylamine groups in copolymerized form, comprising the preparation of a monoethylenically unsaturated N-acylated glycosylamine by a process according to the invention, and the subsequent free-radical polymerization, optionally following the addition of comonomers.

Suitable further comonomers are: other unsaturated N-acylated glycosylamines prepared according to the invention or N-allylglycosides or polymerizable non-sugar monomers, such as (meth)acrylic acid, maleic acid, itaconic acid, the alkali metal or ammonium salts thereof and esters thereof, O-vinyl esters of C1-C25-carboxylic acids, N-vinylamides of C₁-C₂₅-carboxylic acids, N-vinylpyrrolidone, N-vinylcaprolactam, N-vinyloxazolidone, N-vinylimidazole, (meth)acrylamide, (meth)acrylonitrile, ethylene, propylene, butylene, butadiene, styrene. Examples of suitable C₁-C₂₅-carboxylic acids are saturated acids, such as formic acid, acetic acid, propionic acid and n- and isobutyric acid, n- and isovaleric acid, caproic acid, oenanthic acid, caprylic acid, pelargonic acid, capric acid, undecanoic acid, lauric acid, tridecanoic acid, myristic acid, pentadecanoic acid, palmitic acid, margaric acid, stearic acid, nonadecanoic acid, arachidic acid, behenic acid, lignoceric acid, cerotic acid and melissic acid.

The preparation of such polymers takes place, for example, analogously to the processes described in general in “Ullmann's Encyclopedia of Industrial Chemistry, Sixth Edition, 2000, Electronic Release, keyword: Polymerization Process”. Preferably, the (co)polymerization takes places as a free-radical polymerization in the form of the solution polymerization, suspension polymerization, precipitation polymerization or emulsion polymerization or by bulk polymerization, i.e. without solvents.

The invention will now be illustrated in more detail by reference to the following examples:

### EXAMPLE 1

N-Methylmethacrylamido-starch

1.52 kg of an aqueous solution (solids content 18%) of enzymatically partially hydrolyzed starch (254 g, average polar mass according to aqueous GPC 1000 Daltons, main component (30%) maltopentaose) were admixed dropwise at 25° C. with stirring with 42.0 g of an aqueous methylamine solution (40%). After two hours, TEMPOL (4-hydroxy-2,2,6,6-tetramethylpiperidinyl oxide, 1 ppm) is added and the solution is cooled to 0° C. A solution of methacrylic anhydride (88.7 g) in acetone (900 g) is slowly added dropwise at this temperature, the reaction mixture is heated to 25° C. and stirred for a further 12 hours. The constitution of the product was ascertained by means of ¹H- and ¹³C-NMR spectroscopy. It is a mixture of N-methylmethacryl-amido-starch and methacrylic acid in the molar ratio 1:1.

### EXAMPLE 2

N-Methylmaleic acid monoamido-starch

430 g of an aqueous solution (solids content 18%) of enzymatically partially hydrolyzed starch (77.4 g, average molar mass according to aqueous GPC 1000 Daltons, main component (30%) maltopentaose) were admixed dropwise at 25° C. with stirring with 10.0 g of an aqueous methylamine solution (40%). After four hours, a solution of maleoyl chloride (8.53 g) in methanol (50 g) is slowly added dropwise and the reaction mixture is stirred at 25° C. for a further 12 hours. The constitution of the product was ascertained by means of ¹H- and ¹³C-NMR spectroscopy.

### EXAMPLE 3

N-Allylamino-starch

280 g of an aqueous solution (solids content 18%) of enzymatically partially hydrolyzed starch (50.6 g, average molar mass according to aqueous GPC 1000 Daltons, main component (30%) maltopentaose) were admixed dropwise at 25° C. with stirring with 5.40 g of allylamine and the reaction mixture was stirred for 12 hours at 25° C. The constitution of the product was ascertained by means of ¹H- and ¹³C-NMR spectroscopy.

1. A process for preparing a monoethylenically unsaturated glycosylamine, comprising either:
(1) reacting an aldehyde sugar with a primary aliphatic amine or with ammonia or with a mixture thereof in an aqueous medium and then, without interim isolation, with an anhydride of a monounsaturated carboxylic acid, or
(2) reacting an aldehyde sugar directly with allylamine.

2. The process of claim 1, wherein the aldehyde sugar is an aldohexose.

3. The process of claim 1, wherein the aldehyde sugar is an oligosaccharide.

4. The process of claim 1, wherein the aldehyde sugar is obtained by hydrolysis of a polysaccharide.

5. The process of claim 1 wherein the aldehyde sugar is obtained by hydrolysis of cellulose or starch.

6. The process of claim 1, wherein the aldehyde sugar is a compound of formula I, 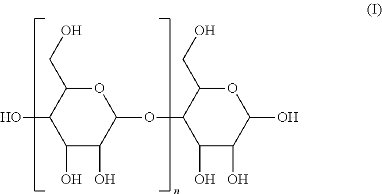
wherein n is 0, 1, 2, 3, 4, 5, 6, 7, or 8.

7. The process of claim 1, comprising reacting the aldehyde sugar with a primary aliphatic amine or with ammonia,
wherein the anhydride of the monounsaturated carboxylic acid is selected from the group consisting of an acrylic anhydride, an anhydride of a C₁-C₆-alkyl-substituted acrylic acid, an itaconic anhydride, and a maleic anhydride.

8. A monoethylenically unsaturated N-maleinylated glycosylamine obtained by the process of claim 1.

9. A monoethylenically unsaturated N-maleinylated glycosylamine of formula II 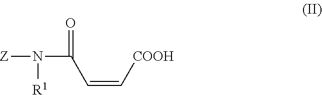
wherein
Z is a radical of an aldehyde sugar, bonded via an anomeric carbon, and
R¹ is hydrogen or C₁-C₈-alkyl which is optionally interrupted by oxygen atoms and which optionally carries one group or two groups independently selected from the group consisting of a carboxyl group, a hydroxyl group, and a carboxamide group.

10. A process for the preparing polymers, comprising:
preparing a monoethylenically unsaturated N-acylated glycosylamine by the process of claim 1, then
optionally adding a comonomer, and then
polymerizing, in a free-radical polymerization, the monoethylenically unsaturated N-acylated glycosylamine and, if added, the optional comonomer.

11. The process of claim 1, comprising reacting the aldehyde sugar with a primary aliphatic amine, wherein the primary aliphatic amine is a C₁-C₈-alkylamine.

12. The monoethylenically unsaturated N-maleinylated glycosylamine of claim 9, wherein Z is a radical of formula III 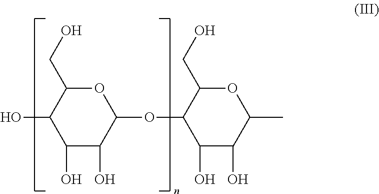
wherein n is 0, 1, 2, 3, 4, 5, 6, 7 or 8.

13. The process of claim 10, wherein the free-radical polymerization comprises solution polymerization, suspension polymerization, precipitation polymerization, emulsion polymerization, or bulk polymerization.

14. The process of claim 1, comprising reacting an aldehyde sugar with a primary aliphatic amine in an aqueous medium and then, without interim isolation, with an anhydride of a monounsaturated carboxylic acid.

15. The process of claim 1, comprising reacting an aldehyde sugar with ammonia in an aqueous medium and then, without interim isolation, with an anhydride of a monounsaturated carboxylic acid.

16. The process of claim 1, comprising reacting an aldehyde sugar with allylamine.

17. The process of claim 1, comprising reacting an aldehyde sugar with a mixture comprising a primary aliphatic amine and ammonia in an aqueous medium and then, without interim isolation, with an anhydride of a monounsaturated carboxylic acid.
